(19) United States
(12) Patent Application Publication
(10) Pub. No.: US 2017/0198441 A1
(43) Pub. Date: Jul. 13, 2017

(54) Base Material For Wallpaper

(71) Applicant: Schoeller Technocell GmbH & Co. KG, Osnabruck (DE)

(72) Inventors: Maximilian Theodor Knapp, Lochgau (DE); Georg Haggenmuller, Unterthingau (DE); Hermann Walter, Titisee-Neustadt (DE); Dennis Najmuschin, Kaufbeuren (DE); Rainer Stelnbeck, Osnabruck (DE)

(21) Appl. No.: 15/324,426

(22) PCT Filed: May 28, 2015
(86) PCT No.: PCT/EP2015/061859

§ 371 Date: Jan. 6, 2017

(30) Foreign Application Priority Data
Jul. 10, 2014 (EP) 14176493.6

(51) Int. Cl. D21H 27/20; D21H 27/36; B32B 27/32; D21H 21/20; B32B 7/02; B32B 27/12; C08J 5/04; D21H 21/16

(52) U.S. Cl. CPC D21H 27/20; C08J 5/045; C08J 5/047; D21H 27/36; D21H 21/16; D21H 21/20; B32B 7/02; B32B 27/12; B32B 27/32; C08J 2301/00; C08J 2433/00; C08J 2479/00; B32B 2262/0276; B32B 2262/062; B32B 2307/4026; B32B 2307/75; B32B 2607/02

(57) ABSTRACT

Described is a base material for dry-peelable wallpaper, having greater dimensional stability and improved printability. The problem is solved by a composite fiber web consisting of a voluminous first layer of fiber material, a thermoplastic polymer film, and a second, less voluminous layer of fiber material.

### TECHNICAL FIELD OF THE INVENTION

The invention relates to a base material for a dry-peelable wallpaper with improved dimensional stability and printability.

### BACKGROUND OF THE INVENTION

The term ‘wallpaper’ is understood to mean a flat wall covering, usually made from paper, glass fibres and/or plastic, which is stuck onto the wall using a suitable adhesive. Wallpapers are usually coloured, printed with patterns, and/or embossed. The different wallpapers are classified on the basis of the materials and manufacturing methods used. The traditional patterned wallpaper is a printed wallpaper made from paper. Embossed or textured wallpaper consists of several layers of paper which are joined together by being embossed with an embossing roller. In order to attach the lengths of wallpaper to the wall, these usually have a glue, in particular wallpaper paste, applied to their reverse side and are subsequently pressed against the wall (wallpapering). In the processing steps such as printing or wallpapering, the impact of water or other liquids brings about expansion and, after subsequent drying, shrinkage of the material.

Over and above this, there are what are known as non-woven wallpapers. The difference from other wallpapers lies chiefly in the substrate. With most non-woven wallpapers, this base consists of a smooth, tear-resistant fibrous material made from cellulose and synthetic fibres (textile fibres and/or plastic fibres).

Non-woven wallpapers have a range of advantages. They do not have to be covered with a wallpaper paste, but can be applied dry, a length at a time, to the wall that has been covered with a special adhesive for non-woven material. They are dimensionally stable and stable during cutting and water vapour-permeable. Compared with conventional paper wallpapers, non-woven wallpapers are largely dimensionally stable in their damp state and on drying. They can be peeled off when dry, because the tensile load-bearing capacity of the non-woven fabric is greater than the adhesive effect of the glue.

A disadvantageous aspect of these non-woven wallpapers, however, is that they do not have optimum printability.

The pastes used to apply wallpapers to the wall are glues in the form of an aqueous swelling product. By way of base substances for pastes, starch and water-soluble organic cellulose compounds are used; these are mixed with appropriate quantities of water. Pastes physically set through evaporation of the water. The pastes may additionally include other components such as synthetic resins, preservatives or agents for increasing or lowering the adhesive power.

The problems of good printability and low wet expansion of the wallpaper substrates are adequately described in the prior art, and various approaches have been proposed for improving the specifications mentioned.

WO 2008/040635 A1 describes a wallpaper substrate with minimal wet expansion and good printability, which consists of two fibre webs matted together by couching. The dimensional stability of the material, however, is not sufficient to reliably avoid the formation of gaps, on drying, between two lengths of wallpaper laid edge to edge.

U.S. Pat. No. 3,294,618 describes a paper product that can be used among other things as a wallpaper substrate. It is produced using a cylindrical sieve [SDW-81] method and consists of several layers of fibrous material. During the manufacturing process, a polymer dispersion is sprayed onto the top (first) wet layer; this is followed by additional layers of paper. After drying and calendering, the polymer particles form a cohesive film intended to form a moisture barrier for the water coming from the wallpaper paste. A decorative plastic film is applied to the outer, lower of the paper structure. A disadvantage is the fact that, as a result of the process-related compression of the upper layer, the wallpaper can only unsatisfactorily compensate for surface irregularities in the wall.

DE 197 54 998 A1 describes wallpapers and their manufacture, whereby two paper webs are, either dry or wet, coated with an adhesive, dried and subsequently the two webs are connected to each other under the impact of heat and/or pressure. According to a further embodiment of this document, the paper webs are connected to each other while incorporating a structure-giving material, preferably metal or plastic.

WO 2010/045201 A2 describes a paper/plastic laminate for use in digital photocopiers and laser printers for electromagnetic shielding.

### SUMMARY OF THE INVENTION

The object of the invention is to provide a base material for a dry-peelable wallpaper which, during further processing, i.e. optional printing and wallpapering, shows improved dimensional stability and very good printability vis-à-vis the prior art.

This object is solved by a base material with a multi-layer composite fibre web which contains at least one first fibre web with one side pointing towards the surface of the object to be coated when the wallpaper is in use, at least one smoothed second fibre web with one side pointing outwards when the wallpaper is in use and at least one layer of a thermoplastic polymer, in particular a polyethylene, extruded between the fibre webs, whereby the first fibre web has a greater specific volume than the second fibre web.

A further subject matter of the invention is a method for producing the base material according to the invention in which one extrudes a molten mass of a thermoplastic resin through a gap formed by a first and a second fibre web and allows it to cool, forming a composite fibre web, whereby the first fibre web has a greater specific volume than the second fibre web.

A further subject matter of the invention is a method for producing a base material according to the invention in which one applies the first fibre web to one side of a plastic film made from a thermoplastic resin and the second fibre web to the other side under the impact of pressure and heat, whereby the first fibre web has a greater specific volume than the second fibre web.

The final subject matter of the invention is a dry-peelable wallpaper containing a base material according to the invention.

### PREFERRED EMBODIMENTS OF THE INVENTION

In a preferred embodiment of the invention, the specific volume of the first voluminous fibre web may be at least 1.3 cm³/g, in particular 1.5 cm³/g to 3.0 cm³/g, preferably however 1.7 cm³/g to 2.4 cm³/g.

The first voluminous fibre web may preferably contain cellulose fibres and additionally polyester fibres in a quantity of up to 50% w/w, in particular 5% w/w to 30% w/w, based on the total quantity of fibres in the fibre web.

In a further embodiment of the invention, the first voluminous fibre web may contain at least two layers of fibrous material that are connected to each other.

The grammage of the voluminous first fibre web may preferably be 30 to 200 g/m², in particular 50 to 120 g/m².

The first fibre web may, in a preferred embodiment, be equipped with a functional layer that improves the peelablity on the side pointing towards the surface of the object to be coated when the wallpaper is in use. This functional layer may for example contain wax dispersions and/or polymer latex.

The specific volume of the second fibre web of the base material according to the invention is preferably less than 1.3 cm³/g, in particular 0.8 cm³/g to 1.2 cm³/g.

In a preferred embodiment of the invention, the second fibre web contains cellulose fibres and no synthetic fibres. Particularly well suited to this embodiment are uncoated or coated papers. These may contain, alongside the cellulose fibres, sizing agents such as alkyl kentene dimers, fatty acids and/or fatty acid salts, epoxidised fatty acid amides, alkenyl or alkyl succinic anhydride, wet strength agents such as polyamine-polyamide-epichlorohydrin, dry strength agents such as anionic, cationic or amphoteric polyamides, optical brighteners, fillers, pigments, colourants, defoamers and other auxiliary agents known in the paper industry. The papers may be surface-sized. Examples of sizing agents suitable for this are polyvinyl alcohol or oxidised starch. Manufacture may take place on a Fourdrinier or a Yankee paper machine (cylinder-type paper machine). The grammage of the papers may be 30 to 250 g/m², in particular 40 to 150 g/m². The papers may be used in uncompressed or compressed form (smoothed). Particularly well suited are papers with a density of 0.5 to 1.1 g/cm³, in particular 0.9 to 1.05 g/cm³.

In a further embodiment of the invention, highly filled papers with a filler content of up to 50% w/w may be used as a second fibre web.

Examples of cellulose fibres which may be used for paper manufacture are bleached hardwood kraft pulp (LBKP), bleached softwood kraft pulp (NBKP), bleached hardwood sulphite pulp (LBSP) or bleached softwood sulphite pulp (NBSP). In addition, cellulose fibres from recycled waste paper can be used. Mixtures of difference cellulose fibres can also be used.

In one particular embodiment of the invention, cellulose fibres from 100% hardwood pulp are used. The average fibre length of the unmilled cellulose is preferably 0.6 to 0.85 mm (Kajaani measurement).

A further embodiment of the invention envisages using a mixture of long-fibre pulp (NBKP) and short-fibre pulp (LBKP) in a ratio of 1:4 to 4:1.

Examples of fillers that can be used according to the invention in the second fibre web are kaolins, calcium carbonate in its natural or ground form for example limestone, marble or dolomite, precipitated calcium carbonate, calcium sulphate, barium sulphate, titanium dioxide, talcum, silica, aluminium oxide and mixtures thereof.

In a further embodiment of the invention, the second fibre web may also contain a pigmented layer on the side pointing outwards. The pigment may be a metal oxide, silicate, carbonate, sulphide or sulphate. Particularly well suited are pigments such as kaolins, talcum, calcium carbonate and/or barium sulphate. Any known water-soluble and/or water-dispersible binder may be used in the pigmented layer. The coating weight may be 0.1 to 30 g/m², in particular 1 to 20 g/m², preferably 2 to 10 g/m².

For the extruded layer of a thermoplastic polymer arranged between the fibre webs according to the invention, polyolefins in particular are suitable, preferably low density polyethylene (LDPE) with a density of less than 0.935 g/cm³ or a mixture of LDPE and HDPE (polyethylene of high density, greater than 0.935 g/cm³) preferably in a quantity ratio of approximately 1:1.

In a further embodiment of the invention, the extruded layer may contain white pigments such as titanium dioxide and further auxiliary agents such as optical brighteners, colourants and dispersion agents.

The application weight of the extruded layer may be 3 to 50 g/m², in particular 5 to 30 g/m², preferably, however, 10 to 20 g/m². In one preferred embodiment of the invention no additional adhesive layer is present between the extruded layer and the two fibre webs.

The fibre webs previously described can be joined together in a laminator by means of extrusion. In the process, a molten thermoplastic mass is introduced through a slot die into the gap between the two fibre webs and the composite web is pressed against a cooling cylinder.

The composite fibre web according to the invention may, on the side pointing towards the surface of the object to be coated, have a Bekk smoothness of less than 20 seconds, preferably of 5 to 20 seconds.

The smoothness on the side of the composite fibre web according to the invention pointing outwards may be at least 20 Bekk seconds, particularly preferably 50 to 300 Bekk seconds. The smoothing of fibre webs can be achieved through calendering or another methode known in the art to smooth papers.

The total grammage of the composite fibre web according to the invention may be 80 g/m² to 500 g/m², in particular 130 g/m² to 250 g/m².

For the manufacture of wallpapers, the base material according to the invention may be printed and/or embossed by a known means. The base material can be painted before and after the printing and embossing.

The following examples help provide further explanation of the invention.

### EXAMPLES

### Example V1 (Comparison)

A non-woven paper was produced from a mixture of four parts by weight hardwood pulp and one part by weight softwood pulp with the addition of synthetic fibres in a quantity of 20% w/w based on the total quantity of cellulose fibres. The concentration of fibres in the low-consistency material was 1% w/w, based on the mass of the fibre suspension. To the low-consistency material were added additives such as a polymeric binder based on an acrylate (Acronal® 2728, BASF SE) in a quantity of 5% w/w, a wet strength agent polyamine-polyamide-epichlorohydrin resin (Kymene®) in a quantity of 6% w/w, and a neutral sizing agent alkyl ketene dimer (AKD) in a quantity of 2% w/w. The quantities stated are based on the mass of the fibrous material. The low-consistency material, whose pH was set at approximately 7.5, was brought from the head box to the wire of the paper machine, whereupon sheet formation occurred with dehydration of the web in the wire section of the paper machine. In the press section, further dehydration of the fibre webito a water content of 60% w/w, based on the web weight, occurred. Further drying took place in the drying section of the paper machine with heated drying cylinders. A non-woven paper with a grammage of 65 g/m² and a moisture content of approximately 5% was produced.

### Examples V2-V4 (Comparison)

By way of comparison, the non-woven materials from the company Dresden Papier GmbH produced using the “Duplex” method were also used (see also WO 2008/040635 A1) and tested for dimensional stability and printability.

The following non-woven materials from Dresden Papier GmbH were tested:
Duplex non-woven wallpaper base, coated 85 g/m² (V2)
Duplex non-woven wallpaper base, coated 90g/m²(V3)
Duplex non-woven wallpaper base, uncoated 150 g/m² (V4).

### Example 5 (Invention)

A paper was produced from a mixture of three parts by weight eucalyptus pulp, one part by weight softwood pulp and kaolin p75 (Prechtel GmbH, Schwetzingen] in a quantity of 15% w/w, based on the mass of the fibrous material. The concentration of the fibres in the low-consistency material was 1% w/w, based on the mass of the cellulose suspension. To the low-consistency material were added polyamine-polyamide-epichlorohydrin resin (Kymene®) as a wet strength agent in a quantity of 6.7% w/w and, as a neutral sizing agent, an alkyl ketene dimer (AKD) in a quantity of 2.9% w/w, based on the mass of the fibrous material. The low-consistency material, whose pH was set at approximately 7.5, was brought from the head box to the wire of the paper machine, whereupon sheet formation occurred with dehydration of the web in the wire section of the paper machine. In the press section, further dehydration of the paper web to a water content of 60% w/w, based on the web weight, occurred. Further drying took place in the drying section of the paper machine with heated drying cylinders. Subsequently, the paper web was calendered. A very smooth paper with a grammage of 30 g/m², a specific volume of 1.1 cm³/g, and a moisture content of approximately 7% was produced.

In the next process step, the non-woven paper from Example VI and the paper produced in Example 5 were joined together in a laminator with a LDPE with a density of 0.924 g/cm³. The application quantity of the polyethylene was 10 g/m². The extrusion lamination took place at a melt temperature of the LDPE of 315° C.

The side of the composite fibre web obtained pointing outwards had a Bekk smoothness of 165 seconds (Bekk method according to DIN 53107). The Bekk smoothness of the side pointing towards the surface of the object to be coated was 7 seconds.

### Example 6 (Invention)

A very smooth paper web was produced from the same low-consistency material and in the same way as in Example 5, but the head box was set in such a way that the grammage of the paper web was 45 g/m², the specific volume 1.15 cm³/g and the moisture content 7%. In the next step, a composite fibre web was produced from the paper web thus obtained, the non-woven paper web from Example VI and LDPE in the same manner as in Example 5.

The Bekk smoothness of the side of the composite fibre web thus obtained pointing outwards was 125 seconds. The Bekk smoothness of the side pointing towards the surface of the object to be coated was 5 seconds.

### Example 7 (Invention)

A paper was produced from a mixture of one part by weight eucalyptus pulp, one part by weight softwood pulp and titanium dioxide in a quantity of 16% w/w, based on the mass of the fibrous material. The concentration of the fibres in the low-consistency material was 1% w/w, based on the mass of the cellulose suspension.

Polyamine-polyamide-epichlorohydrin resin (Kymene®) was added to the low-consistency material as a wet strength agent in a quantity of 1% w/w, based on the mass of the fibrous material. The pH of the low-consistency material was set at approximately 6.5. The low-consistency material was brought from the head box to the wire of the paper machine, whereupon sheet formation occurred with dehydration of the web in the wire section of the paper machine. In the press section, further dehydration of the paper web to a water content of approximately 60% w/w, based on the web weight, took place. Further drying took place in the drying section of the paper machine with heated drying cylinders, and drying and smoothing of the paper took place using a Yankee cylinder. Subsequently, the paper web was calendered. A very smooth paper with a grammage of 130 g/m², a specific volume of 1.15 cm³/g, and a moisture content of approximately 2% was produced.

In the next step, a composite fibre web was produced from the paper web thus obtained, the non-woven paper web from Example VI and LDPE in the same way as in the Examples 5 and 6. The Bekk smoothness of the side of the composite fibre web thus obtained pointing outwards was 61 seconds. The Bekk smoothness of the side pointing towards the surface of the object to be coated was 5 seconds.

The composite fibre webs produced were tested for dimensional stability and printability. Results are summarised in Table 1.

The materials obtained according to the examples and the comparison example were subjected to the tests described below in order to testing the dimensional stability and printability. Wet expansion (internal testing method): The purpose of the test is to determine the expansion dynamics of a wet test strip during one-sided contact with liquid under a defined tensile load after a set traction time.

The test is carried out with the aid of the wet expansion measuring device WSD

Analyzer from Emtec Electronic GmbH. For the test, test strips with the dimensions 60 mm×210 mm are cut out of the material web at right angles to the direction of operation of the machine, fixed in the device holder provided for the purpose and wetted with a test liquid (here: water) and subjected to a tensile force of 1 N for a measurement time of 25 seconds. The electronically generated expansion value is quoted in percent and a mean value calculated from three measurements across the width of the web.

Shrinkage measurement (internal testing method): The purpose of the test is to determine the dynamics of the change in dimensions of the material sample being tested under the influence of heat. The test is carried out with the aid of the HSA Shrinkage Analyzer from Emtec Electronic GmbH. To this end, test strips with the dimensions 60 mm×250 mm are punched out of the material web transverse to the direction of operation of the machine. The test strips are placed, from both sides, onto a wetting tray filled with water. The exposure time per side is 5 seconds. The damp test strips have one end inserted into the clamp of the device provided for the purpose, the other end inserted into a second clamp, and are weighed down with a tensile weight of 200 g. The test strip is lowered onto a plate heated to 210° C. and the shrinkage recorded as a change in length after 2 mins.

The electronically recorded shrinkage value is quoted in percent and a mean value calculated from three measurements across the width of the web.

Printability: The sheets from the example and comparison example web materials were printed using the gravure printing method. For this, a “Printing Proofer” from RK PrintCoat Instruments Ltd., United Kingdom, was used. The gravure plate used has different cell depths in the range 51 μm (for 100% optical printing density) to 5.1 μm (for 10% optical printing density) with a printing density of 150 lines/inch. By way of a printing ink, the water-based gravure ink 7006/10 from Arcolor AG, Switzerland is used. The printed image obtained is visually assessed for optical density, visible sections of non-printed surface and missing dots with grades from 1 (excellent printing quality) to 5 (inadequate printing quality).

The test results are summarised in Table 1.

TABLE 1

| | Wet | | Printability |
|---|---|---|---|
| Example | expansion (%) | Shrinkage (%) | (Grade) |
| V1 | 0.61 | −1.680 | 5 |
| V2 | 0.75 | −1.402 | 3 |
| V3 | 0.50 | −1.592 | 2 |
| V4 | 0.17 | −1.164 | 5 |
| 5 | 0.0 | −0.380 | 2 |
| 6 | 0.0 | −0.460 | 2 |
| 7 | 0.0 | −0.450 | 1 |

The measurement results show that both the wet expansion and the shrinkage behaviour of the materials according to the invention with the composite fibre webs according to the invention were significantly improved; the wet expansion is in fact smaller in the case of the composite fibre webs according to the invention than the values minimally detectable with the testing methods used. In addition the printability of the composite fibre webs according to the invention lies in the range good to excellent.

1. A base material for dry-peelable wallpapers with a multi-layer composite fiber web, comprising a composite fiber web that contains at least one first fiber web with one side pointing towards the surface of the object to be coated when the wallpaper is in use, at least one smoothed second fiber web with one side pointing outwards when the wallpaper is in use and at least one layer of a thermoplastic polymer extruded between the fiber webs, whereby the first fiber web has a greater specific volume than the second smoothed fiber web.

2. The base material according to claim 1, wherein the first fiber web has a specific volume of more than 1.3 cm³/g and the second fiber web has a specific volume of less than 1.3 cm³/g.

3. The base material according to claim 1, wherein the composite fiber web, on the side pointing towards the object to be coated, has a smoothness of less than 20 Bekk seconds.

4. The base material according to claim 1, wherein the composite fiber web, on the side pointing outwards, has a smoothness of at least 20 Bekk seconds.

5. The base material according to claim 1, wherein the extruded layer is a polyolefin layer with a thickness of 5 to 30 g/m².

6. The base material according to claim 1, wherein the voluminous fiber web contains cellulose fibers and polyester fibers in a quantity of 1 to 50% w/w, based on the total quantity of the fibers.

7. The base material according to claim 1, wherein the voluminous fiber web contains at least two layers that are connected to each other.

8. The base material according to claim 1, wherein the grammage of the voluminous first fiber web is 50 to 120 g/m².

9. The base material according to claim 1, wherein the second fiber web does not contain any synthetic fibers.

10. The base material according to claim 1, wherein the second fiber web is a highly compacted paper with a density of 0.9 to 1.05 g/cm³.

11. The base material according to claim 1, wherein the second fiber web is a highly filled paper with a filler content of up to 50% w/w, based on the mass of cellulose.

12. The base material according to claim 1, wherein the second fiber web contains a pigmented layer.

13. A method for producing a base material according to claim 1, said method comprising extruding a molten mass of a thermoplastic resin through a gap formed by a first and a second fiber web, allowing the molten mass of thermoplastic resin to cool, and forming a fiber web composite, whereby the first fiber web has a greater specific volume than the second fiber web and the second fiber web is smoothed.

14. A method for producing a base material according to claim 1, said method comprising applying the first fiber web to one side of a plastic film made from a thermoplastic resin and applying the second fiber web to the other side of the plastic film under the impact of pressure and heat, whereby the first fiber web has a greater specific volume than the second fiber web and the second fiber web is smoothed.

15. A dry-peelable wallpaper containing a base material, comprising a composite fiber web that contains at least one first fiber web with one side pointing towards the surface of the object to be coated when the wallpaper is in use, at least one smoothed second fiber web with one side pointing outwards when the wallpaper is in use and at least one layer of a thermoplastic polymer extruded between the fiber webs, whereby the first fiber web has a greater specific volume than the second smoothed fiber web.
